(19) United States
(12) Patent Application Publication
(10) Pub. No.: US 2017/0004104 A1
(43) Pub. Date: Jan. 5, 2017

(54) USB SWITCH AND CONTROL METHOD THEREOF

(71) Applicant: Fresco Logic, Inc., Beaverton, OR (US)

(72) Inventors: Chistopher M. Meyers, Beaverton, OR (US); Chihte LEE, Taipei City (TW); Jie Ni, Portland, OR (US)

(21) Appl. No.: 15/200,007

(22) Filed: Jul. 1, 2016

Related U.S. Application Data
(60) Provisional application No. 62/188,502, filed on Jul. 3, 2015.

(51) Int. Cl. G06F 13/40; G06F 13/28; G06F 13/16

(52) U.S. Cl. CPC G06F 13/4022; G06F 13/1673; G06F 13/28

(57) ABSTRACT

A universal serial bus (USB) switch includes an upstream port, first downstream ports, M second downstream ports, and a switch engine. The upstream port is configured to have a first bandwidth. Each of the first downstream ports is configured to have a second bandwidth. Each of the M second downstream ports is configured to have a third bandwidth, and M is an integer, and M=0−N, where N is a positive integer greater than or equal to 1. The switch engine is configured to route signals between the upstream port and the totality of first downstream ports, and alternatively to route the signals between the upstream port and one of the M second downstream ports. The third bandwidth is greater than the second bandwidth, and the first bandwidth is a multiple of the second bandwidth.

### CROSS-REFERENCE TO RELATED APPLICATION

This application claims priority to U.S. Provisional Application Ser. No. 62/188,502, filed Jul. 3, 2015 is herein incorporated by reference.

### BACKGROUND

Technical Field

The present disclosure relates to an electronic device. More particularly; the present disclosure relates to a universal serial bus (USB) switch and a control method thereof.

Description of Related Art

A Universal Serial Bus (USB) has become a main specification for data transmission. For example, there are more and more kinds of computer peripheral devices, which include, for example, external hard drives, printers, mice, keyboards and so on, using a USB connector to connect with a computer. However, as the number of the computer peripheral devices using the USB connector is increased, the USB ports provided on the host may no longer be sufficient in number.

To solve the problem of insufficient USB ports, a USB hub is developed. The USB hub is a device that expands a single USB port into several ports so that there are more ports available to connect various computer peripheral devices to a host device.

### SUMMARY

In some aspects, the disclosure provides a universal serial bus (USB) switch. The USB switch includes an upstream port, first downstream ports, M second downstream ports, and a switch engine. The upstream port is configured′ to have a first bandwidth. Each of the first downstream ports is configured to have a second bandwidth. Each of the M second downstream ports is configured to have a third bandwidth, and M is an integer, and M=0−N, where N is a positive integer greater than or equal to 1. The switch engine is configured to route a plurality of signals between the upstream port and the totality of first downstream ports, and alternatively to route the signals between the upstream port and one of the M second downstream ports. The third bandwidth is greater than the second bandwidth, and the first bandwidth is a multiple of the second bandwidth.

In some aspects, the disclosure provides a USB switch. The USB switch includes an upstream port, first downstream ports, second downstream ports, and a switch engine. The upstream port is configured to communicate with a host device without USB 2.0 connectivity. The first downstream ports are configured to communicate with a plurality of USB 2.0 devices. The second downstream ports are configured to communicate with a plurality of USB 3.0 devices. The switch engine is configured to route a plurality of signals between the upstream port and the totality of first downstream ports, and alternatively to route the signals between the upstream port and one of the second downstream ports. The switch engine is further configured to transmit data from the USB 2.0 devices according to a plurality of types of data traffic.

In some aspects, the disclosure provides a control method. The control method includes following operations: sorting and storing, according to types of data traffic, data of USB 2.0 devices, to a first buffer as first data; and transferring, based on the types of the data traffic, one of first data and second data of USB 3.0 devices to a USB host device through an upstream port.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a universal serial bus (USB) switch, according to some embodiments of the present disclosure.

FIG. 2 is a circuit diagram of the USB switch in FIG. 1, according to some embodiments of the present disclosure.

FIG. 3 is a circuit diagram of the switching unit in FIG. 2, according to some embodiments of the present disclosure.

FIG. 4 is a flow chart of a control method, according to the some embodiments of the present disclosure.

FIG. 5 is a schematic diagram of USB stack architecture corresponding to the USB switch in FIG. 1, according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In this document, the term “coupled” may also be termed as “electrically coupled”, and the term “connected” may be termed as “electrically connected”. “Coupled” and “connected” may also be used to indicate that two or more elements cooperate or interact with each other.

It will be understood that, although the terms “first,” “second,” etc., may be used herein to describe various elements, these elements should not be limited by these terms. These terms are used to distinguish one element from another. For example a first element could be termed a second element, and, similarly, a second element could be termed a first element, without departing from the scope of the embodiments. As used herein, the term “and/or” includes any and all combinations of one or more of the associated listed items.

In some aspects, the present disclosure provides a novel universal serial bus (USB) switch to provide the functionality of a hub but with a novel approach and unique features.

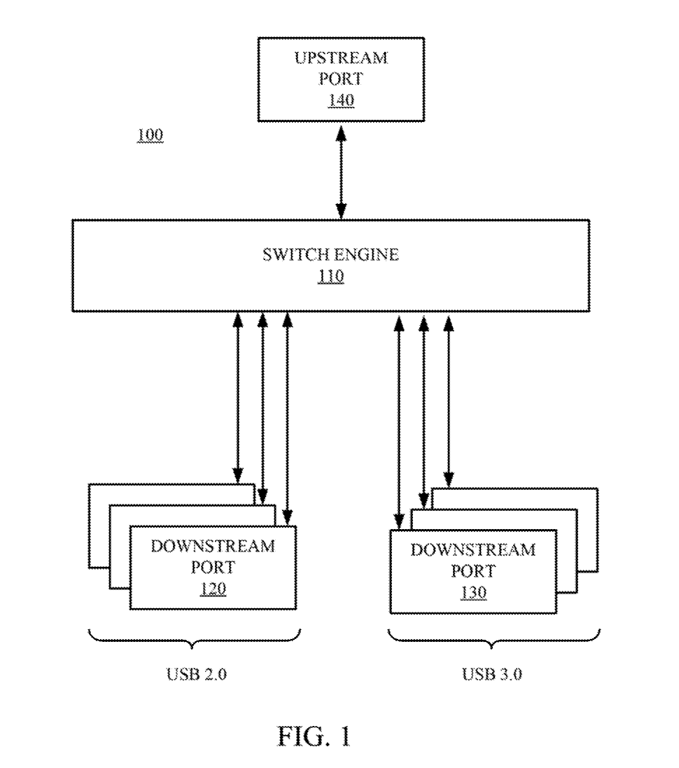

Reference is now made to FIG. 1. FIG. 1 is a schematic diagram of a universal serial bus (USB) switch 100, according to some embodiments of the present disclosure.

As illustratively shown in FIG. 1, the USB switch 100 includes a switch engine 110, downstream ports 120, downstream ports 130, and an upstream port 140.

In some embodiments, each of the downstream ports 120 is configured to have a first bandwidth, each of the downstream ports 130 is configured to have a second bandwidth, and the second bandwidth is greater than the first bandwidth. In some embodiments, the downstream ports 120 are USB 2.0 downstream ports. In some embodiments, the downstream ports 120 are configured to communicate with USB 2.0 devices (not shown).

In some embodiments, the downstream ports 130 are USB 3.0 downstream ports. In some embodiments, the downstream ports 130 are configured to communicate with USB 3.0 devices (not shown).

In some embodiments, the upstream port 140 is coupled to a USB HOST device (not shown), which includes, for example, a personal computer via a SuperSpeed-only connection. For example, in some embodiments, the upstream port 140 is a SuperSpeed USB 3.x upstream port (without USB 2.0 connectivity). In other words, in some embodiments, the upstream port 140 is configured to communicate with the USB HOST device at a speed rate that is at least equal to about five gigabit per second (Gbps). In some embodiments, the term “USB 3.x” indicates USB 3.0, USB 3.1, and/or any later version of the USB standard, and the term “SuperSpeed” indicates any of Gen1, Gen2, or such future standards as may be later defined.

In some embodiments, the upstream port 140 is configured to have a bandwidth that is a multiple of the bandwidth of the downstream port 120. For example, in some embodiments, the bandwidth of the upstream port 140 is at least twice as large as the bandwidth of the downstream port 120. In some embodiments, the number of the downstream ports 120 is not greater than or equal to a predetermined number (e.g., 10) on condition that the upstream port 140 is a USB 3.0 upstream port, and the downstream ports 120 are USB 2.0 downstream ports.

As illustratively shown in FIG. 1, the switch engine 110 is coupled to the downstream ports 120, the downstream ports 130, and the upstream port 140. In some embodiments, the switch engine 110 is configured to route signals between the upstream port 140 and the totality of downstream ports 120, and alternatively to route the signals between the upstream port 140 and the downstream ports 130. For example, with the control of the switch engine 110, USB 2.0 devices (not shown) connected to the downstream port 120 are able to transmit data and/or signals to the USB host device (not shown) connected to the upstream port 140. In other words, in some embodiments, with operations of the switch engine 110, the USB 2.0 device are able to communicate with the USB host device through the SuperSpeed USB 3.x upstream port 140. In some other embodiments, the switch engine 110 is configured to alternately route signals between the upstream port 140 and the total downstream ports 120, and route the signals between the upstream port 140 and one of the downstream ports 130.

In some approaches, a USB hub is designed to have an individual USB 2.0 module and an individual USB 3.0 module. The individual USB 2.0 module includes USB 2.0 downstream ports and a USB 2.0 upstream port that are configured to transfer signals between the USB host device and the USB 2.0 downstream ports. The individual USB 3.0 module includes USB 3.0 downstream ports and a USB 3.0 upstream port that are configured to transfer signals between the USB host device and the USB 3.0 downstream ports.

Compared with the approaches above, with the arrangement of the switch engine 110, the USB 3.0 devices which are connected to the downstream ports 130, and the USB 2.0 devices which are connected to the downstream ports 120, are able to transmit data and/or signals to the USB host device through a single SuperSpeed USB 3.x upstream port 140. Effectively, a bandwidth of the upstream port 140 is shared by the downstream ports 120 and the downstream ports 130. Accordingly, compared with such approaches, the connectivity of the upstream port 140 is able to be simplified.

In some embodiments, the bandwidth of the upstream port 140 is configured to be greater than a total bandwidth of all downstream ports 120. With such a configuration, the USB 2.0 devices that are connected to the downstream ports 120 are able to operate with a full bandwidth. In other words, the bandwidths of the downstream ports 120 are able to be aggregated onto the bandwidth of the single one upstream port 140 without limiting the bandwidth of the USB 2.0 devices. As a result, the transfer efficiency of the USB switch 100 is improved.

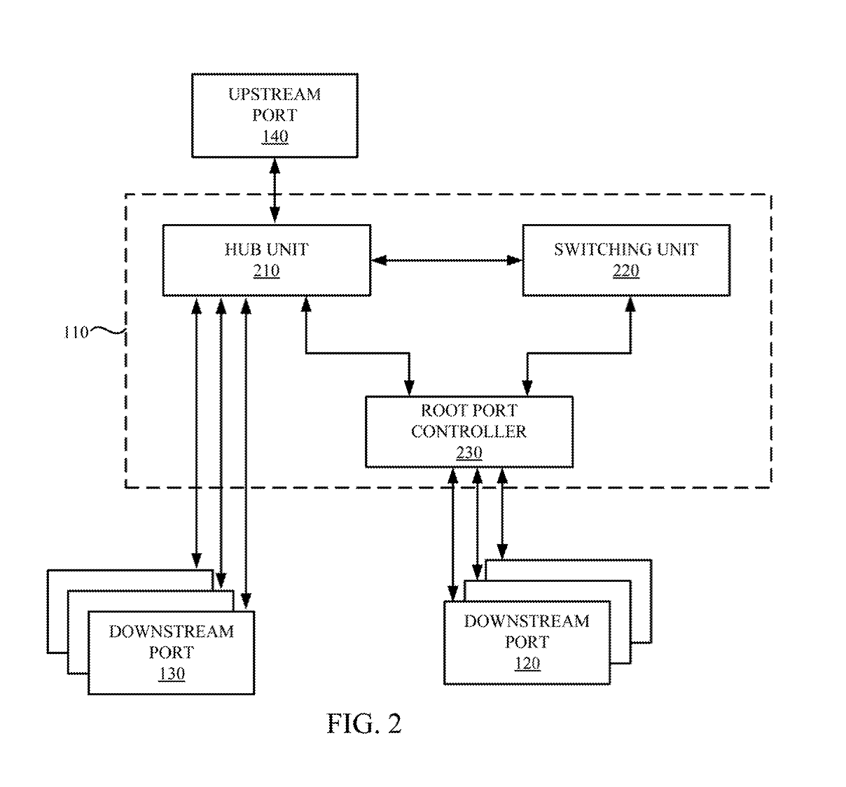

Reference is now made to FIG. 2. FIG. 2 is a circuit diagram of the USB switch 100 in FIG. 1, according to some embodiments of the present disclosure. For ease of understanding, like elements in FIG. 2 are designated with the same reference number in FIG. 1.

As illustratively shown in FIG. 2, the switch engine 110 includes a hub unit 210, a switching unit 220, and a root port controller 230. The hub unit 210 is coupled to the downstream ports 130, the upstream port 140, the switching unit 220, and the root port controller 230. The hub unit 210 is configured to route signals between the upstream port 140 and the totality of downstream ports 120, and alternatively to route the signals between the upstream port 140 and the one of the downstream ports 130. In some other embodiments, the hub unit 210 is configured to alternately route signals between the upstream port 140 and the totality of downstream ports 120, and route the signals between the upstream port 140 and the one of the downstream ports 130.

The switching unit 220 is coupled to the root port controller 230. The root port controller 230 is coupled between the switching unit 220 and the downstream ports 120. The switching unit 220 is configured to transfer signals and/or data between the downstream ports 120 to the upstream port 140. The root port controller 230 is configured to operate as a root hub for the downstream ports 120. In some embodiments, the switching unit 220 is configured to cooperate with the root port controller 230, in order to transfer data and/or signals from all of devices coupled to the downstream ports 120. In some embodiments, the switching unit 220 is configured to cooperate with the root port controller 230, in order to aggregate the total downstream ports 120 as if it were another instance of a downstream port 130. Effectively, the fan-out of an additional USB root port associated with USB 2.0 downstream ports (i.e., downstream ports 120) is generated.

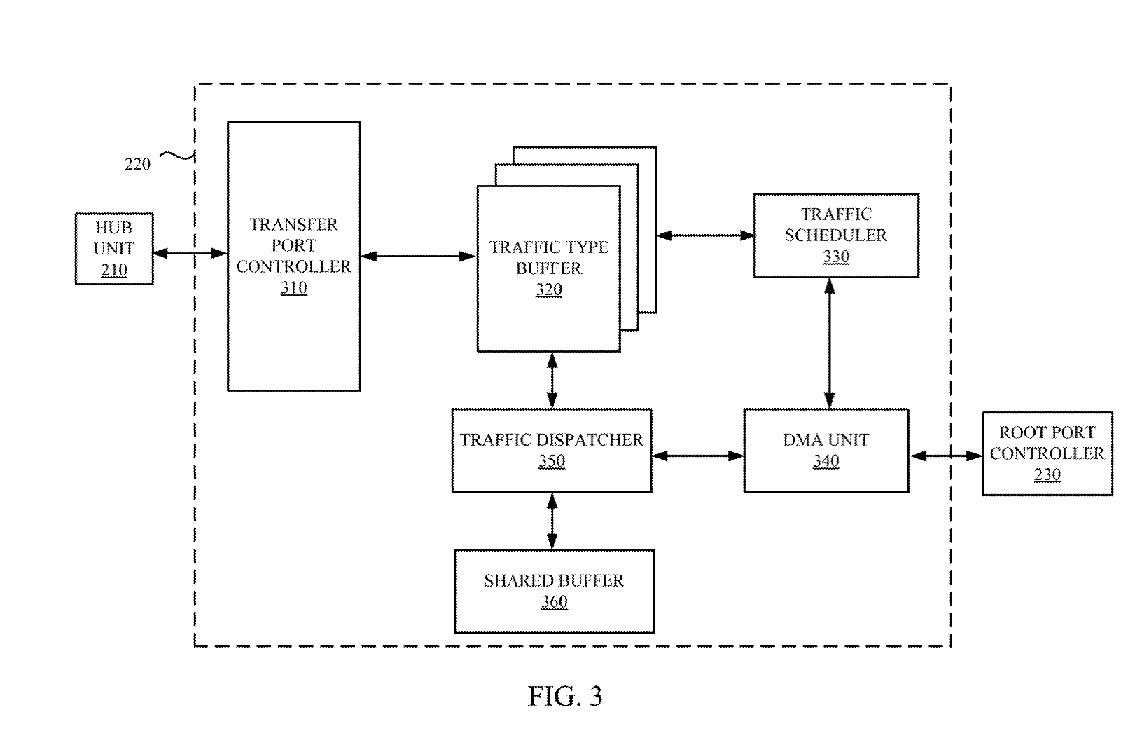

In some embodiments, data from the USB 2.0 devices (not shown), which are connected to the downstream ports 120, are dispatched, by the switching unit 220, to the upstream port 140 according to types of data traffic. The detailed descriptions regarding the operations of the switching unit 220 are provided with reference to FIG. 3 below.

The number of the downstream ports 120 and that of the downstream ports 130 in FIG. 1 and/or FIG. 2 are given for illustrative purposes only. Various numbers of downstream ports 120 and various numbers of the downstream ports 130 in FIG. 1 and/or FIG. 2 are within the contemplated scope of the present disclosure. For example, in some embodiments, the number of the downstream port 120 is one or more. In some embodiments, the number of the downstream port 130 is M, where M is an integer, and is 0−N, in which N is a positive integer, and is greater than or equal to 1.

Reference is now made to FIG. 3. FIG. 3 is a circuit diagram of the switching unit 220 in FIG. 2, according to some embodiments of the present disclosure. For ease of understanding, like elements in FIG. 3 are designated with the same reference number in FIG. 2.

As illustratively shown in FIG. 3, the switching unit 220 includes a transfer port controller 310, traffic type buffers 320, a traffic scheduler 330, a direct memory access (DMA) unit 340, a traffic dispatcher 350, and a shared buffer 360.

The transfer port controller 310 is coupled between the traffic scheduler 330 and the hub unit 210 in FIG. 2. The transfer port controller 310 is configured to determine what signals and/or data, which include, for example, payload data and/or control data, should be transmitted from the traffic type buffers 320 to the upstream port 140. The traffic type buffers 320 are configured to store data from the USB 2.0 devices (not shown) communicated with the downstream ports 120 in response to operations of the traffic scheduler 330.

The traffic scheduler 330 is configured to determine which data or signal transaction requests to process. In some embodiments, the traffic scheduler 330 is configured to perform a scheduling algorithm to manage the sequence of pending tasks of data transfer between the USB host device and the USB 2.0 devices. In some embodiments, the scheduling algorithm is performed to maintain a predetermined bandwidth per interval. In some embodiments, operations of the scheduling algorithm are associated with requirements of the specification of an extensible host controller interface (xHCI).

In some embodiments, the traffic scheduler 330 is configured to schedule data transfers to USB 2.0 devices based on traffic type with the most time-critical traffic going first. For example, various types of the traffic include a bulk traffic, an isochronous traffic, and an interrupt traffic, in which isochronous traffic and interrupt traffic are scheduled before bulk traffic.

In some embodiments, the traffic scheduler 330 is configured to assure that multiple isochronous streams, which are transferred between the downstream ports 120 and the upstream port 140, are scheduled in the appropriate intervals according to the defined properties of each isochronous stream. In some embodiments, the traffic scheduler 330 may take advantage of transfer control information and/or actual transfer data that has been stored in a local shared buffer (e.g., the shared buffer 360) to improve performance. An example of this is caching of a portion of the transfer rings. This prevents multiple short fetches for this data and also decreases the latency, especially important for isochronous data.

In some embodiments, the traffic scheduler 330 is configured to utilize different upstream transfer types to ensure status information about transfers that are time-critical are delivered with a low and consistent latency. For example, transfer completion events or other control information is sent via interrupt transfer types. Compared to using bulk transfers, latency is reduced and the variability of performance as a factor of system loading is also reduced.

In some embodiments, the traffic scheduler 330 is configured to combine transfer data and status information from multiple USB 2.0 devices, which are coupled to the downstream ports 120, into larger upstream transfers. As a result, timely data delivery is allowed and overhead is reduced to improve the performance.

In some embodiments, the traffic scheduler 330 is configured to transfer data from multiple USB 2.0 devices, which are coupled to the downstream ports 120, even if the entire transfer from the multiple USB 2.0 devices is not complete. With such configuration, the amount of data that is delayed is reduced. As a result, the storage in local memory is freed up, and the performance is further improved.

The DMA unit 340 is coupled to the root port controller 230. The DMA unit 340 is configured to transfer data and/or signals between upstream port 140 and the downstream ports 120, and to transfer payload data between a host bus (not shown) and the root port controller 230. The traffic dispatcher 350 is coupled between the traffic type buffers 320 and the DMA unit 340. The traffic dispatcher 350 is configured to dispatch the data from the USB 2.0 device, communicated with the downstream ports 120, to the traffic type buffers 320. In some embodiments, the traffic dispatcher 350 is configured to sort and store, according to the types of the traffic, data from the USB 2.0 devices (not shown) communicated with the downstream ports 120 to the traffic type buffers 320.

The arrangements and the configurations of the switching unit 220 are given for illustrative purposes only. Various functional circuits, which are able to be applied with a USB hub/switch/device, are within the contemplated scope of the present disclosure. For example, in some other embodiments, the shared buffer 360 is replaced with individual buffers, which are associated with the USB 2.0 devices communicated with the downstream ports 120.

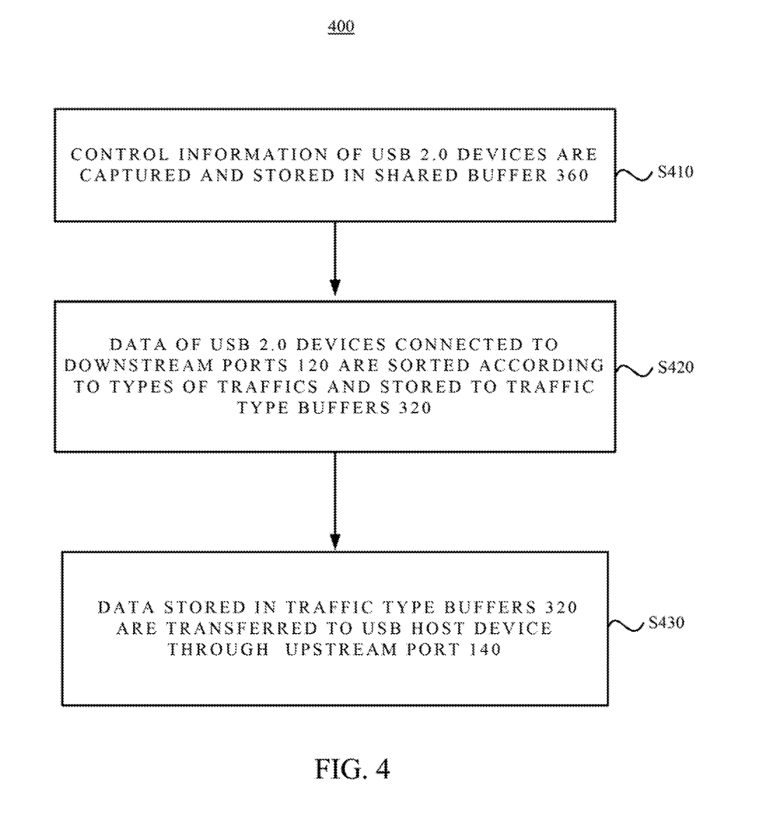

Reference is now made to both of FIG. 3 and FIG. 4. FIG. 4 is a flow chart of a control method 400, according to the some embodiments of the present disclosure. As an example, the operations of the control method 400 are described with the operations of the switching unit 220 in FIG. 3.

In some embodiments, the control method 400 includes operations S410, S420, and S430. In operation S410, control information of the USB 2.0 device are captured and stored in the shared buffer 360.

For illustration, a USB host controller (not shown), which is included in the host device communicated with the upstream port 140, periodically detects whether at least one USB 2.0 device is connected to the downstream ports 120. In some embodiments, such periodical detection of the USB host controller is referred to as “polling.” If a USB 2.0 device is connected to one of the downstream ports 120, the USB host controller will require control information regarding the connected USB 2.0 device. In some embodiments, the control information will include an identification (ID) of the connected USB 2.0 device, type of traffics of stored data, active status, etc. The traffic dispatcher 350 captures the control information of the connected USB 2.0 device, and then stores the same in the shared buffer 360.

With continued reference to FIG. 4, in operation S420, data of the USB 2.0 devices connected to the downstream ports 120 are sorted according to the types of the traffics and stored to the traffic type buffers 320. As described above, in some embodiments, various types of the traffic include the bulk traffic, the isochronous traffic, and the interrupt traffic. The bulk traffic is a traffic having a reliable requirement but without dictated time sensitivity. In some embodiments, the bulk traffic is used to transfer large bursty data. In some embodiments, the isochronous traffic is a time-sensitive traffic, and occurs continuously and periodically. In some embodiments, the interrupt traffic is a time-sensitive traffic and requires a reliable delivery requirement. In some embodiments, the interrupt traffic is typically non-periodic communication requiring bounded latency.

In some embodiments, as described above, in the operation S410, the traffic dispatcher 350 are able to receive the type of the traffic corresponding to data from the totality of downstream ports 120, according to information stored in the shared buffer 360. The traffic dispatcher 350 then sorts the data from the downstream ports 120 according to the type of the traffic. For example, the traffic dispatcher 350 is able to combine and store the data from different USB 2.0 devices communicated with the totality of downstream ports 120, which correspond to the bulk traffic, to one of the traffic type buffers 320. Similarly, the traffic dispatcher 350 is able to combine and store the data from different USB 2.0 devices communicated with the downstream ports 120, which correspond to the isochronous traffic, to another one of the traffic type buffers 320.

In some embodiments, the bulk traffics in the USB 2.0 devices are all mapped to data and/or signals corresponding to the bulk traffic stored in the shared buffer 360. The isochronous traffics in the USB 2.0 devices are all mapped to data and/or signals corresponding to the isochronous traffic stored in the shared buffer 360. Also, the interrupt traffics in the USB 2.0 devices are all mapped to data and/or signals, corresponding to the interrupt traffic, stored in the shared buffer 360. With the mapping of the types of the traffic, the data from the USB 2.0 devices are able to be combined in the traffic type buffers 320. Accordingly, it is ensured that one type of data traffic will not block one another type of data traffic. As a result, the quality of the data transmission is improved.

With continued reference to FIG. 4, in operation S430, the data stored in the traffic type buffers 320 are transferred to the USB host device through the upstream port 140. For illustration, the transfer port controller 310 in FIG. 3 cooperates with the hub unit 210 in FIG. 2 to transmit the data and/or signals stored in traffic type buffers 320 to the USB host device (not shown) via the upstream port 140, and vice versa. In other words, in some embodiments, with the configuration of the switching unit 220 in FIG. 3, the USB 2.0 devices connected to the totality of downstream ports 120 are able to communicate with the USB host device via the SuperSpeed USB 3.x upstream port 140. In some embodiments, a mixture of the data stored in the USB 2.0 devices, which is connected to the downstream ports 120, and the data stored in the SuperSpeed USB 3.0 devices, which are connected to the downstream ports 130, transferred to and from a USB host device through the upstream port 140.

The above description regarding the method 400 includes exemplary operations, but the operations are not necessarily performed in the order described. The order of the operations disclosed in the present disclosure are able to be changed, or the operations are able to be executed simultaneously or partially simultaneously as appropriate, in accordance with the spirit and scope of various embodiments of the present disclosure.

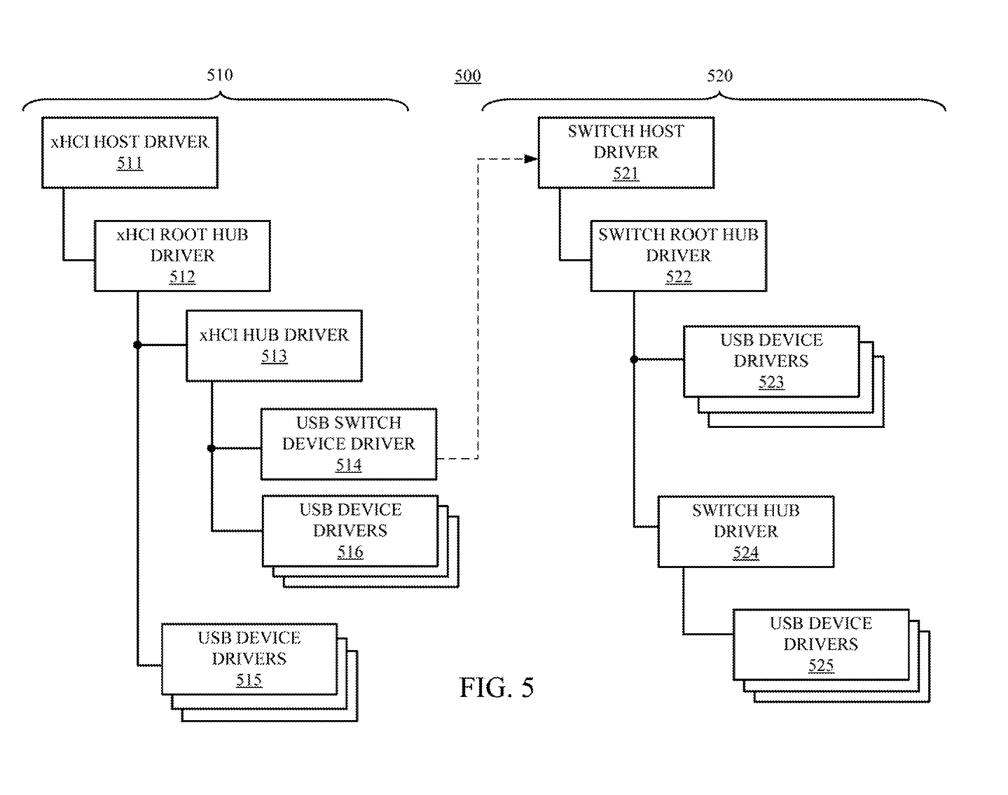

Reference is now made to FIG. 5. FIG. 5 is a schematic diagram of USB stack architecture 500 corresponding to the USB switch 100 in FIG. 1, according to some embodiments of the present disclosure.

As described above, in some embodiments, with the arrangement of the root port controller 230 in FIG. 2, the fan-out of the additional USB root port is generated. For illustration, as shown in FIG. 5, the USB stack architecture 500, which corresponds to the USB switch 100 in FIG. 1, is provided. In some embodiments, the USB stack architecture 500 indicates a hierarchical tree control in the USB switch 100 in FIG. 1. The elements in the USB stack architecture 500 are implemented by software, hardware, or the combination thereof, in some embodiments. For example, in some embodiments, the USB stack architecture 500 is able to be shown in a device manager of an operating system of the USB host device.

As shown in FIG. 5, the USB stack architecture 500 includes a standard USB driver stack 510 and an additional USB driver stack 520. In some embodiments, main elements in the standard USB driver stack 510 correspond to elements of the USB host device. For illustration, the standard USB driver stack 510 includes an xHCI driver 511, an xHCI root hub driver 512, an xHCI hub driver 513, and USB device drivers 515 and 516. The xHCI root hub driver 512 is arranged at a lower layer of the xHCI driver 511. The xHCI hub driver 513 and USB device drivers 515 are arranged at a lower layer of the xHCI root hub driver 512. The USB device drivers 516 correspond to the USB 3.0 devices that are connected through the downstream ports 130 in FIG. 1 and are arranged at a lower layer of the xHCI hub driver 513.

Furthermore, in some embodiments, a USB switch device driver 514 is configured and corresponds to the switching unit 220 in FIG. 2. The USB switch device driver 514 indicates an additional USB tree (i.e., the additional USB driver stack 520), which includes USB 2.0 devices that are connected through the downstream ports 120 in FIG. 3, in which the USB 2.0 devices are expanded with the switching unit 220 and root port controller 230 in FIG. 2.

The additional USB driver stack 520 corresponds to the switching unit 220 in FIG. 2 and USB 2.0 devices communicated with the USB switch 100. For illustration, the additional USB driver stack 520 includes a switch host driver 521, a switch root hub driver 522, USB device drivers 523, a switch hub driver 524, and USB device drivers 525. The switch root hub driver 522 corresponds to the root port controller 230 in FIG. 2, and is arranged at a lower layer of the switch host driver 521. The USB device drivers 523 correspond to USB 2.0 devices that are connected to the downstream ports 120. The switch hub driver 524 corresponds to USB 2.0 hubs connected to the downstream ports 120 (not shown), and is arranged at a lower layer of the switch root hub driver 522. The USB device drivers 525 correspond to USB 2.0 devices that are connected to the downstream ports 120 through a USB 2.0 hub.

Accordingly, with the arrangement of the USB switch 100 in FIG. 1, an additional USB tree, which includes the connection among the USB 2.0 devices and the USB 3.0 devices, are expanded from the USB host device. Thus, data and/or signals are able to be transferred between the USB host device and multiple USB 2.0 devices and/or USB 3.0 devices.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this invention provided they fall within the scope of the following claims.

What is claimed is:

1. A universal serial bus (USB) switch, comprising:
an upstream port configured to have a first bandwidth;
a plurality of first downstream ports, wherein each of the first downstream ports is configured to have a second bandwidth;
M second downstream ports, wherein each of the M second downstream ports is configured to have a third bandwidth, M is an integer, and M=0−N, where N is a positive integer greater than or equal to 1; and
a switch engine configured to route a plurality of signals between the upstream port and the totality of first downstream ports, and alternatively to route the signals between the upstream port and one of the M second downstream ports,
wherein the third bandwidth is greater than the second bandwidth, and the first bandwidth is a multiple of the second bandwidth.

2. The USB switch of claim 1, wherein the first downstream ports are configured to communicate with a plurality of USB 2.0 devices, and the M second downstream ports are configured to communicate with M USB 3.0 devices.

3. The USB switch of claim 1, wherein the upstream port is configured to communicate with a host device via a USB 3.0 interface or a USB 3.1 interface without USB 2.0 connectivity.

4. The USB switch of claim 1, wherein the switch engine comprises:
a hub unit configured to route the signals between the upstream port and the one of the totality of first downstream ports, and alternatively to route the signals between the upstream port and the one of the M second downstream ports;
a switching unit configured to transfer the signals between the first downstream ports to the upstream port; and
a root port controller configured to communicate with the first downstream ports.

5. The USB switch of claim 4, wherein the root port controller is configured to operate as a root hub for the first downstream ports.

6. The USB switch of claim 4, wherein the switching unit comprises:
a plurality of traffic type buffers configured to store data from a plurality of first devices that communicated with the first downstream ports;
a transfer port controller configured to determine at least one of signal transmission between the traffic type buffers to the upstream port;
a traffic scheduler configured to process a signal transaction from the first devices; and
a traffic dispatcher configured to dispatch the data from the first devices to the traffic type buffers according to control information indicating a plurality of types of data traffic.

7. The USB switch of claim 6, wherein the switching unit further comprises:
a direct memory access unit configured to transfer the data between the first devices and to transfer payload data between a host bus and the root port controller; and
a shared buffer configured to store the data and control information.

8. The USB switch of claim 6, wherein the traffic scheduler is configured to perform a scheduling algorithm to maintain a predetermined bandwidth per interval.

9. The USB switch of claim 6, wherein the traffic dispatcher is configured to sort and store, according to the types of the traffic, the data from the first devices to the traffic type buffers.

10. A universal serial bus (USB) switch, comprising:
an upstream port configured to communicate with a host device without USB 2.0 connectivity;
a plurality of first downstream ports configured to communicate with a plurality of USB 2.0 devices;
a plurality of second downstream ports configured to communicate with a plurality of USB 3.0 devices;
a switch engine configured to route a plurality of signals between the upstream port and the totality of first downstream ports, and alternatively to route the signals between the upstream port and one of the second downstream ports,
wherein the switch engine is further configured to transmit data from the USB 2.0 devices according to a plurality of types of data traffic.

11. The USB switch of claim 10, wherein each of the first downstream ports are configured to have a first bandwidth, each of the second downstream ports is configured to have a second bandwidth, and the second bandwidth is greater than the first bandwidth.

12. The USB switch of claim 11, wherein the upstream port is configured to a third bandwidth, and the third bandwidth is a multiple of the first bandwidth.

13. The USB switch of claim 10, wherein the switch engine comprises:
a hub unit configured to route the signals between the upstream port and the totality of first downstream ports, and alternatively route the signals between the upstream port and the one of the second downstream ports;
a switching unit configured to transfer the signals from the first downstream ports to the upstream port; and
a root port controller configured to communicate with the first downstream port.

14. The USB switch of claim 13, wherein the root port controller is configured to operate as a root hub for the first downstream ports.

15. The USB switch of claim 14, wherein the switching unit comprises:
a plurality of traffic type buffers configured to store data from a plurality of first devices that communicated with the first downstream port;
a transfer port controller configured to determine at least one of signal transmission from the traffic type buffers to the upstream port;
a traffic scheduler configured to process a signal transaction from the first devices; and
a traffic dispatcher configured to dispatch the data from the first devices to the traffic type buffers according to control information indicating a plurality of types of data traffic.

16. The USB switch of claim 15, wherein the switching unit further comprises:
a direct memory access unit configured to transfer the data from the first devices and to transfer payload data between a host bus and the root port controller; and
a shared buffer configured to store the control information.

17. The USB switch of claim 15, wherein the traffic dispatcher is configured to sort and store, according to the types of the traffic, the data from the first devices to the traffic type buffers.

18. A control method, comprising:
sorting and storing, according to types of data traffic, data of a plurality of universal serial bus (USB) 2.0 devices, to a first buffer as first data; and
transferring, based on the types of the data traffic, one of first data and second data of a plurality of USB 3.0 devices to a USB host device through an upstream port.

19. The control method of claim 18, further comprising:
capturing control information indicating the types of the data traffic; and
storing the control information to a second buffer.

20. The control method of claim 19, wherein sorting the data of the USB 2.0 devices comprises:
sorting and storing the data of a plurality of USB 2.0 devices to the first buffer according to the control information stored in the second buffer.
